(19) United States
(12) Patent Application Publication
(10) Pub. No.: US 2010/0138878 A1
(43) Pub. Date: Jun. 3, 2010

(54) RECEIVER CIRCUIT OF SATELLITE DIGITAL VIDEO BROADCAST SYSTEM

(75) Inventors: Pan Soo Kim, Daeieon (KR); Joon Gyu Ryu, Daejeon (KR); Dae Ig Chang, Daejeon (KR); Ho Jin Lee, Daejeon (KR); Myung Hoon Sunwoo, Suwon (KR); Jin Kyu Choi, Suwon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/629,522

(22) Filed: Dec. 2, 2009

(30) Foreign Application Priority Data
Dec. 2, 2008 (KR) 10-2008-0121234
Aug. 25, 2009 (KR) 10-2009-0078691

(51) Int. Cl. H04N 7/20; H04B 1/707

(52) U.S. Cl. 725/70; 375/150

(57) ABSTRACT

A receiver circuit of a satellite digital video broadcast system includes: a multiplication unit outputting a synchronized reception symbol by multiplying a reception symbol by frequency error information as a feedback; a common autocorrelation unit acquiring autocorrelation values for each symbol by multiplying the synchronized reception symbol by an autocorrelation coefficient; a frame synchronization unit detecting a SOF (Start Of Frame), which is a synchronization word indicating start of a frame, from the autocorrelation values for each symbol; a frequency synchronization unit estimating the frequency error information based on the autocorrelation values for each reception symbol and the SOF; and an SNR estimation unit estimating an SNR (Signal to Noise Ratio) based on the autocorrelation values for each symbol and the SOF.

### CROSS-REFERENCE TO RELATED APPLICATIONS

This application claims the priority of Korean Patent Application No. 10-2008-0121234 filed on Dec. 2, 2008 and Korean Patent Application No. 10-2009-0078691 filed on Aug. 25, 2009, in the Korean Intellectual Property Office, the disclosure of which is incorporated herein by reference.

### BACKGROUND OF THE INVENTION

1. Field of the Invention

The present invention relates to a receiver circuit of a satellite digital video broadcast system, and more particularly, to a European-type satellite digital video broadcast system to which DVB-S2 specifications are applied.

2. Description of the Related Art

DVB-S (Digital Video Broadcasting via Satellite) specifications applied to European-type satellite digital video broadcast system are satellite digital video broadcast standards developed in Europe which are now widely used in the satellite broadcasts of many countries.

However, the DVB-S2 (Digital Video Broadcasting via Satellite Generation 2) specifications in which the frequency efficiency is improved in comparison with the DVB-S specifications were developed in accordance with developments in satellite broadcast technology and continuously developing consumer demand in 2003.

The DVB-S2 specifications increase channel capacity by 30%, compared to the existing DVB-S specifications, and allow for high transmission efficiency as well as more reliable transmissions.

Under the above-described DVB-S2 specifications, in order to ensure maximal frequency efficiency, an LDPC (Low Density Parity Check) code must reach a QEF (Quasi Error Free) state.

Thus, a receiver circuit of a satellite digital video broadcast system to which the DVB-S2 specifications are applied should be able to efficiently detect the start position of a frame and estimate and compensate for frequency errors even in an environment in which the frequency errors (for example, frequency errors corresponding to a maximum 20% of a symbol speed) are very great and a Signal to Noise Ratio (SNR) is low, (for example, an SNR of −2.35 dB).

FIG. 1 is a diagram illustrating the configuration of a receiver circuit of a satellite digital video broadcast system according to the related art.

As shown in FIG. 1, the receiver circuit of a satellite digital video broadcast system is configured to include: a frame synchronization unit 11 that receives a reception symbol Rx and detects frame start information; a frequency synchronization unit 12 that receives the reception symbol Rx and the frame start information and estimates frequency error information \hat{f}ₑ; a multiplication unit 13 that synchronizes the reception symbol Rx by multiplying the reception symbol Rx by the frequency error information \hat{f}ₑ; and an SNR estimation unit 14 that receives the synchronized reception symbols Sy-Rx through the multiplication unit 13 as an input and estimates the SNR.

In other words, a typical receiver circuit has a structure in which the frame synchronization unit 11, the frequency synchronization unit 12, and the SNR estimation unit 14 are connected to an input terminal in series.

Under such a structure, the performances of the frame synchronization unit 11 and the frequency synchronization unit 12 are highly influenced by noises added to the reception symbol Rx and the frequency error. In addition, there is a serious problem that the entire synchronization circuit operates abnormally in a case where the frame synchronization unit 11 operates abnormally.

As a result, it is difficult for the receiver circuit having the above-described structure to provide sufficient performance in an environment in which frequency errors are very great and the SNR is low, that is, a communications environment complying with the DVB-S2 specifications.

On the other hand, all the algorithms applied to the frame synchronization unit 11, the frequency synchronization unit 12, and the SNR estimation unit 14 are based on data support using a training sequence and perform detection of the frame start position, estimation of the frequency error, and the estimation of the SNR by using the autocorrelation for the training sequence.

Accordingly, each of the frame synchronization unit 11, the frequency synchronization unit 12, and the SNR estimation unit 14 must include an autocorrelation calculation circuit (module). Thus, there is a problem in that the complexity of the receiver circuit increases.

### SUMMARY OF THE INVENTION

An aspect of the present invention provides a receiver circuit of a satellite digital video broadcast system having a new structure that can provide sufficient performance even in a communications environment complying with the DVB-S2 specifications and can decrease the circuit complexity.

According to an aspect of the present invention, there is provided a receiver circuit of a satellite digital video broadcast system. The receiver circuit includes: a multiplication unit outputting a synchronized reception symbol by multiplying a reception symbol by frequency error information as feedback; a common autocorrelation unit acquiring autocorrelation values for each symbol by multiplying the synchronized reception symbol by an autocorrelation coefficient; a frame synchronization unit detecting a SOF (Start Of Frame), which is a synchronization word indicating a start of a frame from the autocorrelation values for each symbol; a frequency synchronization unit estimating the frequency error information based on the autocorrelation values for each reception symbol and the SOF; and an SNR estimation unit estimating an SNR (Signal to Noise Ratio) based on the autocorrelation values for each symbol and the SOF.

The common autocorrelation unit may include: a plurality of symbol delay sections connected to an input terminal in series and outputting a plurality of delayed reception symbols by delaying each of the synchronized reception symbols by one symbol; and a plurality of autocorrelation sections acquiring the autocorrelation values for each reception symbol by multiplying the plurality of delayed reception symbols by a plurality of autocorrelation coefficients.

Each of the plurality of symbol delay sections may be implemented by a D-flip-flop.

The SNR estimation unit may further have a function of supplying the SNR or an SOF detection reference corresponding to the SNR to the frame synchronization unit.

The satellite digital video broadcast system may comply with DVB-S2 specifications.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating the configuration of a receiver circuit of a satellite digital video broadcast system according to typical technology;

FIG. 2 is a diagram illustrating the configuration of a receiver circuit of a satellite digital video broadcast system according to an embodiment of the present invention;

FIG. 3 is a diagram illustrating a detailed configuration of a common autocorrelation unit according to an embodiment of the present invention;

FIG. 4 is a diagram illustrating an example of a frame synchronization unit that is implemented by using a common autocorrelation unit according to an embodiment of the present invention; and

FIG. 5 is a diagram illustrating an example of a frequency synchronization unit that is implemented by using a common autocorrelation unit according to an embodiment of the present invention.

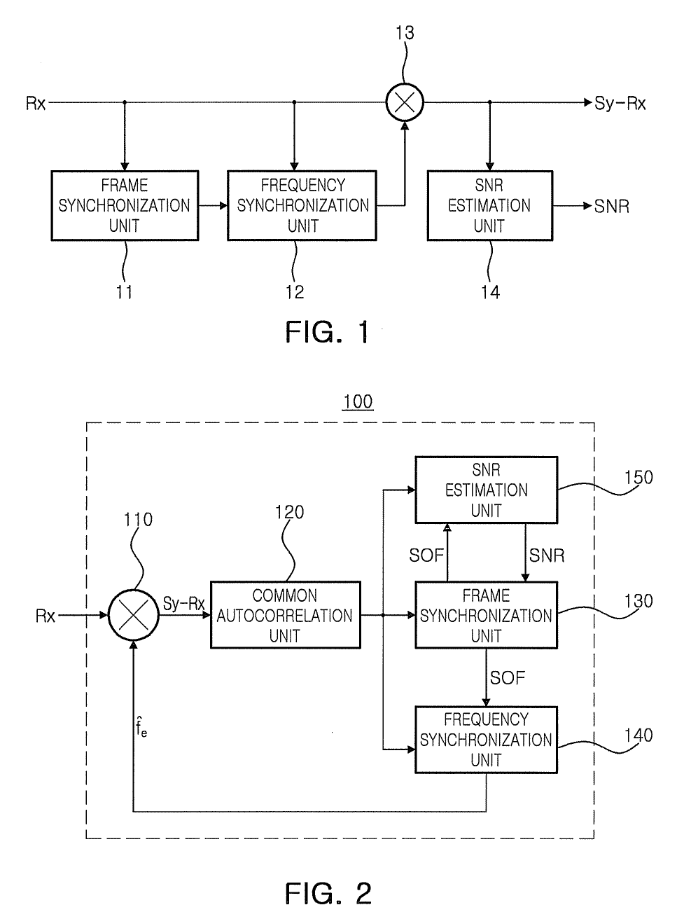

### DETAILED DESCRIPTION OF THE PREFERRED EMBODIMENT

Hereinafter, exemplary embodiments of the present invention will be described in detail with reference to the accompanying drawings, which will fully convey the concept of the invention to those skilled in the art. Moreover, detailed descriptions related to well-known functions or configurations will be ruled out in order not to unnecessarily obscure the subject matter of the present invention. It is also noted that like reference numerals denote like elements in appreciating the drawings.

It will be understood that when an element is referred to as being “connected to” another element, it can be directly connected to the other element or intervening elements may also be present. In contrast, when an element is referred to as being “directly connected to” another element, there are no intervening elements present. In addition, unless explicitly described to the contrary, the word “comprise” and variations such as “comprises” or “comprising,” as well as the word “include” and variations such as “includes” and “including,” will be understood to imply the inclusion of stated elements but not the exclusion of any other elements.

Before describing the embodiments of the present invention, algorithms used for detecting a frame start position, a frequency-error estimation, and SNR estimation will be described in order to facilitate understanding of the present invention.

First, algorithms used for detecting the frame start position include NCPDI (Non-Coherent Post Detection Integration), DPDI (Differential Post Detection Integration), GPDI (Generalized Post Detection Integration), and D-GPDI (Differential-Generalized Post Detection Integration) algorithms. In these algorithms, autocorrelation acquired by using the following Equation 1 is used. The algorithms can be expressed in numeric equations represented as the following Equations 2 to 5.

$$\begin{matrix}{x}_{i} = {\sum }_{m = iM}^{( i + 1 ) M - 1} {r}_{m} {c}_{m} & Equation 1 \\ {Λ}^{NCPDI} = {\sum }_{k = 0}^{L - 1} {\vert {x}_{k} \vert}^{2} & Equation 2 \\ {Λ}^{n \text{-} Span DPDI} = \vert {\sum }_{k = n}^{L - 1} {x}_{k} {x}_{k - n}^{*} \vert & Equation 3 \\ {Λ}^{GPDI} = {Λ}^{NCPDI} + 2 {\sum }_{n = 1}^{L - 1} {Λ}^{n \text{-} SpanDPDI} & Equation 4 \\ {Λ}^{D \text{-} GPDI} = 2 {\sum }_{n = 1}^{{L}_{SOF - 1}} {Λ}^{n \text{-} SpanDPDI} & Equation 5\end{matrix}$$

Here, rₘ is a reception symbol, cₘ is an autocorrelation coefficient, M is a length of a Coherent sum, and L is a length of PDI (Post Detection Integration).

Next, algorithms used for frequency-error estimation include M&M (Mengali and Morelli), L&R (Luise & Reggiannini), and Fitz algorithms. In these algorithms, autocorrelation acquired by using Equation 6 is used. The algorithms can be expressed in equations represented by the following Equations 7 to 9.

$$\begin{matrix}{R}_{n} ( k ) = \frac{1}{L - k} {\sum }_{i = k}^{{L}_{p} - 1} {r}_{i} {{c}_{i}^{*} ( {r}_{i - k} {c}_{i - k}^{*} )}^{*} , 0 \leq k \leq M - 1 & Equation 6 \\ \hat{f} \text{?} = \frac{1}{2 π {T}_{s}} {\sum }_{k = 1}^{M} {l}_{k} arg [ {R}_{n} ( k ) {R}_{n}^{*} ( k - 1 ) ] \\ {l}_{k} = \frac{( L - 1 ) ( L - k + 1 ) - M ( L - M )}{M ( 4 {M}^{2} - 6 ML + 3 {L}^{2} - 1 )} & Equation 7 \\ \hat{f} \text{?} = \frac{1}{π {T}_{s} ( M + 1 )} arg \{ {\sum }_{k = 1}^{M} {R}_{n} ( k ) \} & Equation 8 \\ \hat{f} \text{?} = \frac{2}{π {T}_{s} M ( M + 1 )} {\sum }_{k = 1}^{M} arg \{ {R}_{n} ( k ) \} \\ \text{?} \text{indicates text missing or illegible when filed} & Equation 9\end{matrix}$$

Here, cᵢ is an i-th training symbol, Tₛ is a symbol time, and M is a design parameter that is less than L/2.

Finally, as algorithms used for SNR estimation, there are an ML (Maximum Likelihood) algorithm, an SNV (Signal-to-Noise Variance) algorithm, and the like. These algorithms can be expressed in equations represented as the following Equations 10 to 11.

$$\begin{matrix}\hat{f} \text{?} = \frac{2}{π {T}_{s} M ( M + 1 )} {\sum }_{k = 1}^{M} arg \{ {R}_{n} ( k ) \} & Equation 10 \\ {\hat{ρ}}_{SNV} = \frac{{[ \frac{1}{N} {\sum }_{m = 0}^{N - 1} {r}_{m} {c}_{m}^{*} ]}^{2}}{\frac{1}{N} {\sum }_{m = 0}^{N - 1} {r}_{m}^{2} - {[ \frac{1}{N} {\sum }_{m = 0}^{N - 1} {r}_{m} {c}_{m}^{*} ]}^{2}} \\ \text{?} \text{indicates text missing or illegible when filed} & Equation 11\end{matrix}$$

Here, N is the length of an estimation symbol and may be the length of an SOF symbol.

In all of the algorithms, the algorithm for detecting the frame start position, the algorithm for estimating the frequency error, and the algorithm for estimating the SNR, autocorrelation for the training signal sequence (or autocorrelation coefficient) is used, as represented in the above-described equations.

In other words, in a case where the autocorrelation

$${(}^{``} {\sum }_{m = iM}^{( i + 1 ) M - 1} {r}_{m} {{c}_{m}}^{″} {,}^{``} {\sum }_{i = k}^{L - 1} {r}_{i}^{n} {{c}_{i}^{*}}^{″} , {and }^{``} {\sum }_{m = 0}^{N - 1} {r}_{m} {{c}_{m}^{*}}^{″} )$$

using the above-described algorithms are implemented as a circuit. It can be noticed that the circuit is implemented by components that have a same structure and perform a same function.

Thus, in an embodiment of the present invention, autocorrelation calculation circuits (or modules) that are included in a frame synchronization unit 11, a frequency synchronization unit 12, and an SNR estimation unit 14 in a duplicate manner are integrated as a single circuit by using the characteristics of the above-described algorithms.

FIG. 2 is a diagram illustrating the configuration of a receiver circuit of a satellite digital video broadcast system according to an embodiment of the present invention.

As shown in FIG. 2, the receiver circuit 100 of a satellite digital video broadcast system according to an embodiment of the present invention includes a multiplication unit 110, a common autocorrelation unit 120, a frame synchronization unit 130, a frequency synchronization unit 140, and an SNR estimation unit 150. In particular, the frame synchronization unit 130, the frequency synchronization unit 140, and the SNR estimation unit 150 are connected to the common autocorrelation unit 120 in parallel.

Hereinafter, the functions of the constituent elements will be described.

The multiplication unit 110 eliminates the frequency error of a reception symbol Rx by multiplying the reception symbol Rx input to the receiver circuit 100 by frequency error information \hat{f}ₑ that is a feedback from the SNR estimation unit 150. In other words, the multiplication unit 110 synchronizes the reception symbol (Sy-Ry). Accordingly, the frame synchronization unit 130 receives a signal from which frequency error is constantly eliminated as an input and can thus perform a stable operation even in an environment of relatively large frequency errors.

The common autocorrelation unit 120 has autocorrelation coefficients set in advance and acquires an autocorrelation value for each reception symbol by multiplying the reception symbol (Sy-Rx), which is synchronized by the multiplication unit 110, by an autocorrelation coefficient. Then, the common autocorrelation unit 120 supplies the acquired autocorrelation values for each reception symbol to the frame synchronization unit 130, the frequency synchronization unit 140, and the SNR estimation unit 150.

The frame synchronization unit 130 detects SOF (Start Of Frame) which is a synchronization word indicating the start of a frame from the autocorrelation value for each symbol, which is supplied from the common autocorrelation unit 120, by using the NCPDI algorithm, the DPDI algorithms, the GPD1 algorithm, the D-GPDI algorithm, or the like.

The frequency synchronization unit 140 estimates the frequency error \hat{f}ₑ based on the autocorrelation value for each reception symbol supplied from the common autocorrelation unit 120 and the SOF that is detected through the frame synchronization unit 130 by using the M&M algorithm, the L&R algorithm, the Fitz algorithm, or the like. Then, the frequency synchronization unit 140 feeds the estimated frequency error \hat{f}ₑ back to the multiplication unit 110.

The SNR estimation unit 150 estimates the SNR based on the autocorrelation value for each reception symbol, which is output from the common autocorrelation unit 120, and the SOF detected though the frame synchronization unit 130 by using the ML algorithm, the SNV algorithm, or the like. Then, the SNR estimation unit 150 supplies the SNR or an SOF detection reference (that is, a threshold value normalized for noise deviations) corresponding to the SNR to the frame synchronization unit 130.

As a reference, as the SNR decreases, excessive noise is included. Thus, the frame synchronization unit 130 is characterized in that G-DPDI energy rapidly increases as the SNR decreases. Accordingly, the probability of misdetection of the SOF for the frame synchronization unit 130 can be decreased by having the SOF detection references that are changed in accordance with the SNR at the time of detection of the SOF.

Accordingly, in an embodiment of the present invention, the SNR estimation unit 150 helps the frame synchronization unit 130 to operate stably even in a low-SNR environment, by notifying the frame synchronization unit 130 of the SNR or the SOF detection reference corresponding to the SNR.

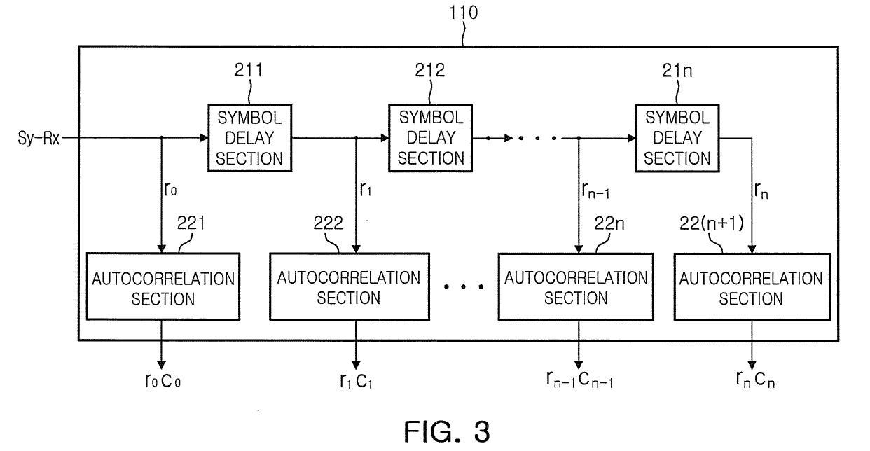

FIG. 3 is a diagram illustrating a detailed configuration of a common autocorrelation unit according to an embodiment of the present invention.

As shown in FIG. 3, the common autocorrelation unit 110 is configured to include a plurality of symbol delay sections 211 to 21n that are connected in series to an input terminal in and a plurality of autocorrelation sections 221 to 22 (n+1) that are connected in correspondence with the symbol delay sections 211 to 21n.

Each of the plurality of symbol delay sections 211 to 21n can be implemented by using a D-filpflop to delay the reception symbols Rx by one symbol so as to output a plurality of delayed reception symbols r₀ to rₙ.

The plurality of autocorrelation sections 221 to 22(n+1) have autocorrelation coefficients c₀ to cₙ corresponding thereto. The plurality of autocorrelation sections 221 to 22(n+1) calculates and outputs the autocorrelation values r₀c₀ to rₙcₙ for each reception symbol by multiplying the plurality of delayed reception symbols r₀ to rₙ output from the plurality of symbol delay sections 211 to 21n by the autocorrelation coefficients c₀ to cₙ.

As described above, when receiving the reception symbol Rx as an input, the common autocorrelation unit represented in FIG. 3 generates a plurality of reception symbols r₀ to rᵣ, delayed through the plurality of symbol delay sections 211 and 21n and generates autocorrelation values r₀c₀ to rₙcₙ for each reception symbol through the plurality of autocorrelation sections 221 to 22(n+1). In other words, the common autocorrelation unit according to an embodiment of the present invention calculates the autocorrelation values in accordance with the above-described Equations 1 to 6.

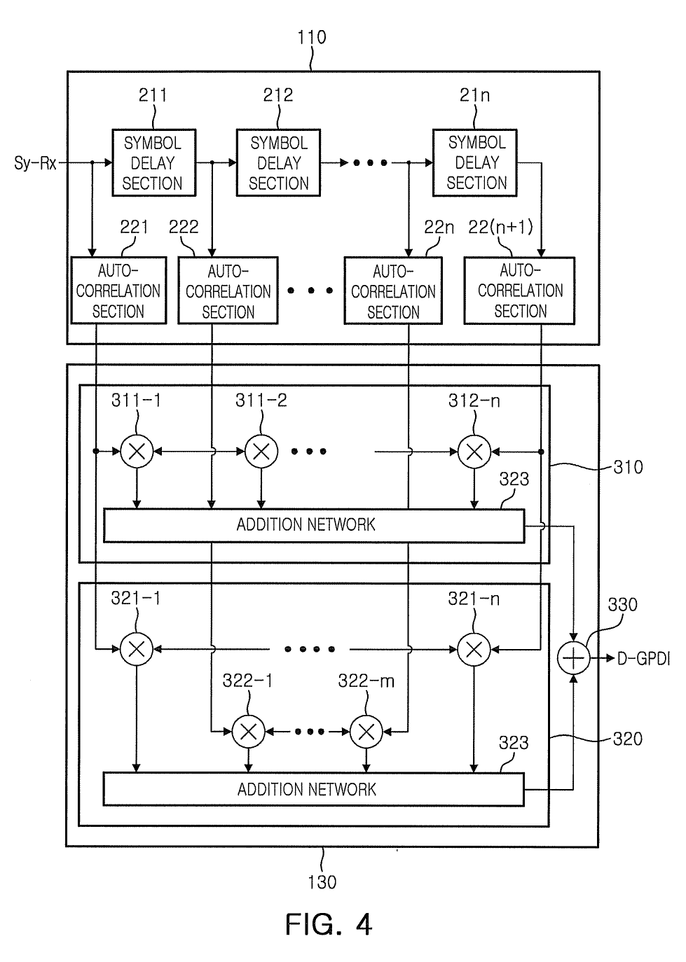

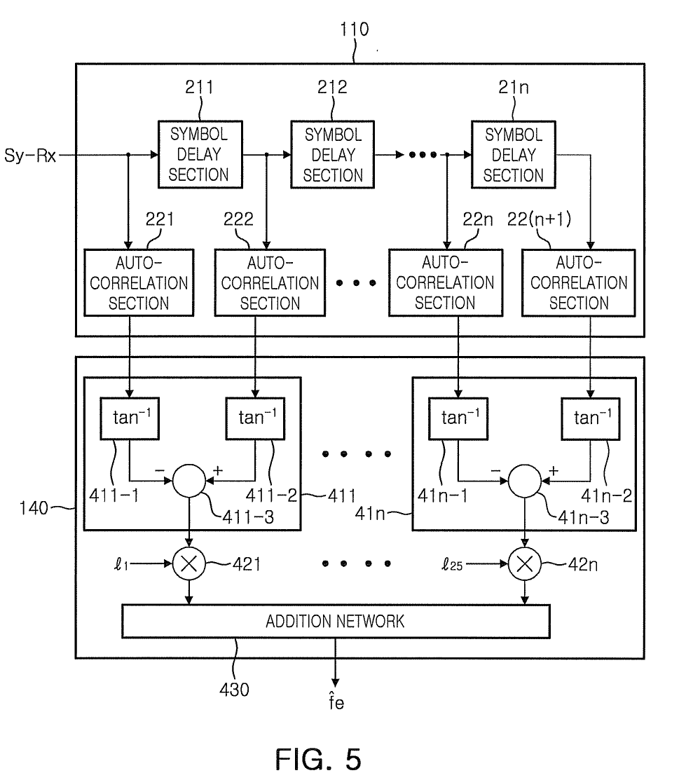

FIGS. 4 and 5 are diagrams illustrating an example of the frame synchronization unit and the frequency synchronization unit that are implemented by using the common autocorrelation unit according to an embodiment of the present invention. Here, for convenience of description, only the frame synchronization unit that uses the D-GPDI algorithm and the frequency synchronization unit that uses the M&M algorithm will be described.

As shown in FIG. 4, the frame synchronization unit 130 includes a 1-span DPDI 310, a 2-span DPDI 320, and an adder 330 that are connected to the common autocorrelation unit 120 in multiple stages. The frame synchronization unit 130 implements the D-GPDI algorithm by using the autocorrelation values r₀c₀ to rₘcₘ for each symbol that are transmitted from the common autocorrelation unit 120.

In such a case, the 1-span DPDI 310 is configured to have a plurality of multipliers 311-1 to 311-n that multiply the autocorrelation values of the consecutive reception symbols and an addition network 320 that adds and outputs output signals of the plurality of multipliers 311-1 to 311-n. In addition, the 2-span DPDI 320 is configured by a plurality of first multipliers 321-1 to 321-n that multiply the autocorrelation values of the consecutive reception symbols, a plurality of second multipliers 322-1 to 322-m that multiply the autocorrelation values of the consecutive reception symbols, and the addition network 320 that adds and outputs the output signals of the plurality of the first and second multipliers 311-1 to 311-n. The adder 330 adds and outputs output signals of the 1-span DPDI 310 and the 2-span DPDI 320.

As shown in FIG. 5, also the frequency synchronization unit 140 implements the M&M algorithm by using the autocorrelation values r₀c₀ to rₘcₘ for each reception symbol that is transmitted from the common correlation unit 120.

In such a case, the frequency synchronization unit 140 is configured to have a plurality of tangent calculators 411-1 to 41n-2 that are connected to the plurality of autocorrelation sections 221 to 22(n+1) of the common autocorrelation unit 120, a plurality of adders 411-3 to 41n-3 that subtract one of output signals of two tangent calculators (for example, 411-1 and 411-2) and add the other, a plurality of multipliers 421 to 42n that multiply output signals of the adders 411-3 to 41n-3 by weighting factors Iₗ to Iₖ set in advance, and an addition network 430 that adds and outputs output signals of the plurality of multipliers 421 to 42n.

Although not described here, the SNR estimation unit 150 can also implement the ML algorithm, the SNV algorithm, or the like in the same manner by using the autocorrelation values r₀c₀ to rₘcₘ for each reception symbol transmitted from the common autocorrelation unit 120.

As described above, in this embodiment, the frame synchronization unit 130, the frequency synchronization unit 140, and the SNR estimation unit 150 commonly use the common autocorrelation unit 120 shown in FIG. 3, whereby the complexity of the entire circuit is markedly decreased.

A receiver circuit of a satellite digital video broadcast system according to an embodiment of the present invention lowers circuit complexity by integrating autocorrelation calculation circuits (or modules) included in the frame synchronization unit, the frequency synchronization unit, and the SNR estimation unit in a duplicate manner as a single circuit.

In addition, the frame synchronization unit, the frequency synchronization unit, and the SNR estimation unit operate in parallel, and necessary information is exchanged therebetween, whereby stable performance can be ensured even in a poor communications environment. In other words, by eliminating the frequency error included in the reception symbol input to the frame synchronization unit through the frequency error that is acquired through the frequency synchronization unit, the frame synchronization unit can stably operate even in a communications environment having a relatively high frequency error rate. In addition, by actively changing the transmission mode thereof in accordance with the SNR and a SOF detection reference (that is, a threshold value normalized for the noise deviations) of the SNR estimation unit through the SNR estimation unit, the frame synchronization unit can stably operate even in an environment having a relatively low SNR.

Furthermore, according to an embodiment of the present invention, a shortened response time can be acquired based on the circuit structure optimized by the common autocorrelation unit integrated as a single circuit and the frame synchronization unit, the frequency synchronization unit, and the SNR estimation unit connected thereto in parallel. Accordingly, rapid changes in a channel and environmental conditions can be responded efficiently in a timely manner.

While the present invention has been shown and described in connection with the exemplary embodiments, it will be apparent to those skilled in the art that modifications and variations can be made without departing from the spirit and scope of the invention as defined by the appended claims.

What is claimed is:

1. A receiver circuit of a satellite digital video broadcast system, the receiver circuit comprising:
a multiplication unit outputting a synchronized reception symbol by multiplying a reception symbol by frequency error information as feedback;
a common autocorrelation unit acquiring autocorrelation values for each symbol by multiplying the synchronized reception symbol by an autocorrelation coefficient;
a frame synchronization unit detecting a SOF (Start Of Frame), which is a synchronization word indicating a start of a frame, from the autocorrelation values for each symbol;
a frequency synchronization unit estimating the frequency error information based on the autocorrelation values for each reception symbol and the SOF; and
an SNR estimation unit estimating an SNR (Signal to Noise Ratio) based on the autocorrelation values for each symbol and the SOF.

2. The receiver circuit of claim 1, wherein the common autocorrelation unit comprises:
a plurality of symbol delay sections connected to an input terminal in series and outputting a plurality of delayed reception symbols by delaying each of the synchronized reception symbols by one symbol; and
a plurality of autocorrelation sections acquiring the autocorrelation values for each reception symbol by multiplying the plurality of delayed reception symbols by a plurality of autocorrelation coefficients.

3. The receiver circuit of claim 2, wherein each of the plurality of symbol delay sections is implemented by a D-flip-flop.

4. The receiver circuit of claim 1, wherein the SNR estimation unit has a further function of supplying the SNR or an SOF detection reference corresponding to the SNR to the frame synchronization unit.

5. The receiver circuit of claim 1, wherein the satellite digital video broadcast system complies with DVB-S2 specifications.
